(19) United States
(12) Patent Application Publication
(10) Pub. No.: US 2026/0271959 A1
(43) Pub. Date: Sep. 17, 2026

(54) REFRIGERATOR WITH ICE CREAM MAKER

(71) Applicant: North Atlantic Imports, LLC, Logan, UT (US)

(72) Inventors: Christopher L. Hanks, Nibley, UT (US); Ryan D. Tirrell, North Logan, UT (US)

(73) Assignee: North Atlantic Imports, LLC, Logan, UT (US)

(21) Appl. No.: 19/562,496

(22) Filed: Mar. 10, 2026

Related U.S. Application Data
(60) Provisional application No. 63/770,701, filed on Mar. 12, 2025.

(51) Int. Cl. A23G 9/12; A23G 9/22; F25D 11/02; F25D 23/12; F25D 25/02

(52) U.S. Cl. CPC A23G 9/12; A23G 9/224; A23G 9/227; F25D 11/02; F25D 23/12; F25D 25/025

(57) ABSTRACT

A refrigerator including a refrigeration compartment and a freezer compartment, where a freezer drawer is configured for selectively accessing the freezer compartment. The refrigerator further includes an ice cream maker mounted within the freezer compartment. The ice cream maker includes a motor positioned rearward of the freezer drawer, and a drive shaft movably connected to the motor and extending at least partially within the freezer drawer. The drive shaft engages with the motor when the freezer drawer is in a first position and disengages with the motor when the freezer drawer is in a second position.

### CROSS-REFERENCE TO RELATED APPLICATION

This application claims priority to and the benefit of U.S. Provisional Patent Application No. 63/770,701, filed on Mar. 12, 2025, the entire contents of which are incorporated by reference herein.

### BACKGROUND

The present disclosure relates generally to the field of food storage appliances, such as refrigerators and freezers. More specifically, the present disclosure relates to devices, systems, and methods for making ice cream within a freezer compartment of a refrigerator.

### SUMMARY

One embodiment relates to a refrigerator including a refrigeration compartment and a freezer compartment, where a freezer drawer is configured for selectively accessing the freezer compartment. The refrigerator further includes an ice cream maker mounted within the freezer compartment. The ice cream maker includes a motor positioned rearward of the freezer drawer, and a drive shaft movably connected to the motor and extending at least partially within the freezer drawer. The drive shaft engages with the motor when the freezer drawer is in a first position and disengages with the motor when the freezer drawer is in a second position.

Another embodiment relates to a food storage appliance including a freezer compartment and an ice cream maker. The ice cream maker includes a housing connected to an interior surface of the freezer compartment, where the housing defining an opening. The ice cream maker further includes a bowl positioned within the opening of the housing and rotatable relative to the housing, and a mixing blade fixedly coupled to the housing and extending within the opening of the housing into the bowl. The ice cream maker further includes a rotatable plate connected to a bottom surface of the bowl, and a motor and a drive shaft movably connected to the rotatable plate. The motor rotates the bowl relative to the mixing blade using the rotatable plate.

In some embodiments, the bowl includes one or more grooves formed in a bottom of the bowl, and the rotatable plate includes one or more protrusions configured to mate with the one or more grooves of the bowl. In some embodiments, the mixing blade includes a first end, a mixing portion, and a second end, and where the mixing portion is positioned within the bowl, and the first end and the second end extend outward from the mixing portion and outside the bowl. In some embodiments, the mixing blade further comprises the first end and the second end bent downward. In some embodiments, the housing further includes one or more grooves formed in the housing around a circumference of the opening, and where the first end and the second end of the mixing blade are inserted into the one or more grooves to connect the mixing blade to the housing.

In some embodiments, the ice cream maker further includes one or more gears positioned between the drive shaft and the rotatable plate, where the one or more gears change an axis of rotation of the rotatable plate relative to the drive shaft. In some embodiments, the ice cream maker further includes a retainer positioned over an outer edge of the bowl, where the retainer maintains a lid on the bowl during rotation of the bowl.

In some embodiments, the bowl includes a lip positioned on an outer edge of the bowl and extending around a circumference of the bowl, and where the lip rests on a top surface of the housing when the bowl is inserted into the opening. In some embodiments, the housing further includes a second opening defined in the housing adjacent to the opening, and wherein a second bowl is positioned within the second opening.

### BRIEF DESCRIPTION OF THE DRAWINGS

FIG. 1 is a perspective view of an embodiment of a refrigerator.

FIG. 2A is a section view of the refrigerator, in accordance with an illustrative embodiment.

FIG. 2B is a section view of a freezer compartment of a refrigerator including an ice cream maker, in accordance with to an illustrative embodiment.

FIG. 3 is a perspective view of a freezer compartment including the ice cream maker, according to another illustrative embodiment.

FIG. 4A is a perspective view of an embodiment of the ice cream maker.

FIG. 4B is a perspective view of another embodiment of the ice cream maker.

FIGS. 5A-5B are exploded views of an embodiment of the ice cream maker.

FIGS. 6A-6D are perspective views of components of the ice cream maker, in accordance with various illustrative embodiments.

FIG. 7A is a section view of a refrigerator including a freezer compartment including the ice cream maker in a closed position, in accordance with an illustrative embodiment.

FIG. 7B is a perspective view of a refrigerator including a freezer compartment including the ice cream maker in a closed position, in accordance with another illustrative embodiment.

FIG. 8A is a section view of a refrigerator including a freezer compartment including the ice cream maker in an open position, in accordance with an illustrative embodiment.

FIG. 8B is a perspective view of a refrigerator including a freezer compartment including the ice cream maker an open position, in accordance with another illustrative embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In an embodiment of a refrigerator, the refrigerator includes a refrigeration compartment and a freezer compartment, where a freezer drawer is configured for selectively accessing the freezer compartment. The refrigerator further includes an ice cream maker mounted within the freezer compartment. The ice cream maker includes a motor positioned rearward of the freezer drawer, and a drive shaft movably connected to the motor and extending at least partially within the freezer drawer. The drive shaft engages with the motor when the freezer drawer is in a first (e.g., closed) position and disengages with the motor when the freezer drawer is in a second (e.g., open) position.

In an embodiment of a food storage appliance, the appliance includes a freezer compartment and an ice cream maker positioned within the freezer compartment. The ice cream maker includes a housing connected to an interior surface of the freezer compartment, where the housing defines an opening, and a bowl positioned within the opening of the housing and rotatable relative to the housing. The ice cream maker further includes a mixing blade fixedly coupled to the housing and extending within the opening of the housing into the bowl, and a rotatable plate connected to the bottom surface of the bowl. The ice cream maker further includes a motor and a drive shaft movably connected to the rotatable plate, where the motor rotates the bowl relative to the mixing blade using the rotatable plate.

The refrigerator and/or the food storage appliance integrates the ice cream maker into the refrigerator and/or the appliance, improving user convenience and access to the ice cream maker, as well as the resulting ice cream. By integrating the ice cream maker into the food storage appliance, the user does not need to purchase a free-standing ice cream maker. Nor does the user need to manually connect and/or disconnect the motor from the rest of the ice cream maker to access and/or prepare ice cream. And integration of the ice cream maker ensures the ice cream maker remains upright in the freezer compartment to avoid spillage, as well as limiting interference of the rotating blade. Furthermore, to integrate the ice cream maker, the motor of the ice cream maker being positioned outside the freezer drawer simplifies mounting of the motor and provides more efficient energy use (e.g., the motor does not have to be mounted within the freezer drawer, or on the freezer drawer). The configuration of the ice cream maker having the bowl rotatable relative to the mixing blade optimizes mounting of the ice cream maker within the freezer drawer. And the mixing blade being fixed within the housing when making ice cream simplifies maintenance and cleaning for the ice cream maker (e.g., easily removable blade lowers risk of the user accidentally cutting themselves on the blade, mixing blade can be dishwasher safe to simplify cleaning). Therefore, the ice cream maker being mounted in the freezer drawer and/or being configured with the bowl rotatable relative to the mixing blade provides convenience for a user to homemade ice cream within their own refrigerator and/or food storage appliance.

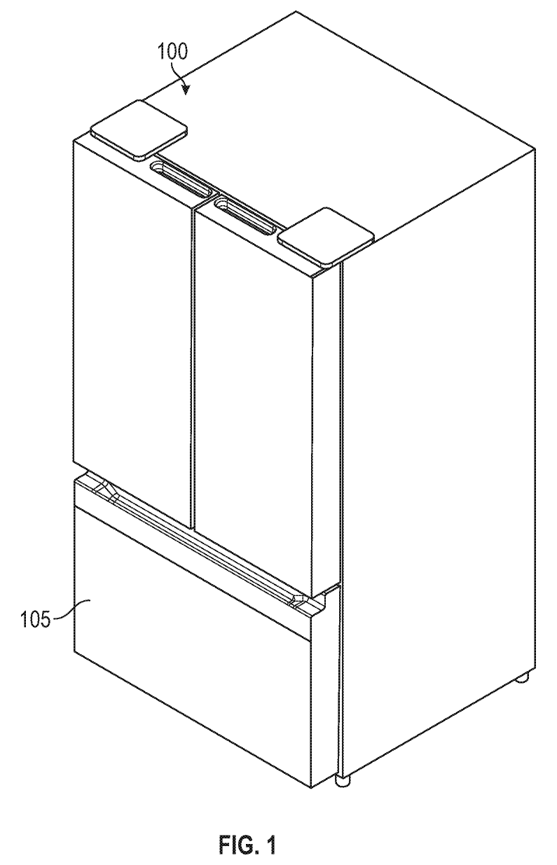

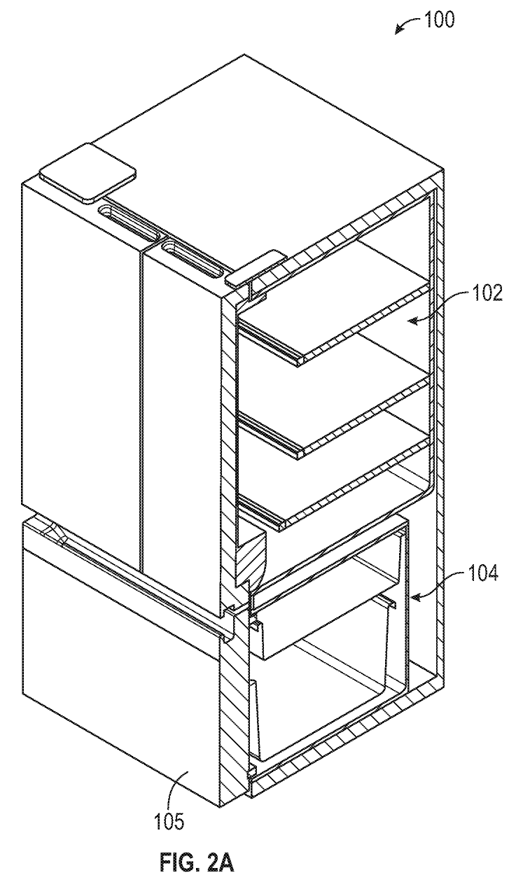

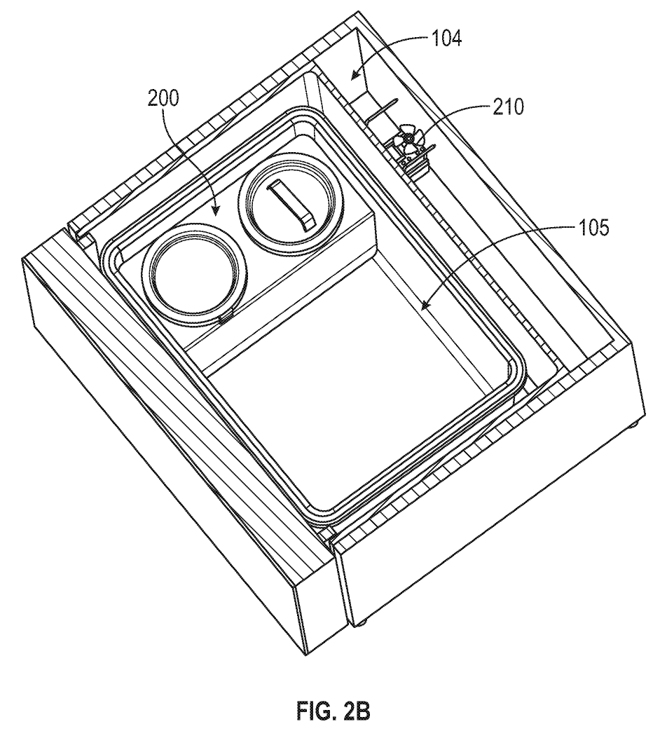

Referring to FIGS. 1-2B, a food storage appliance, shown as refrigerator 100, is depicted. The refrigerator 100 includes a refrigeration compartment 102 and a freezer compartment 104, where a freezer drawer 105 is configured for selectively accessing the freezer compartment 104. The refrigeration compartment 102 is positioned above the freezer compartment 104 (e.g., a bottom freezer refrigerator model). The refrigerator 100 further includes an ice cream maker 200 mounted within the freezer compartment 104. The ice cream maker 200 may be at least partially mounted on an interior surface of the freezer drawer 105. In some embodiments, the ice cream maker 200 may be configured for use within freezer compartments without freezer drawers, such as other refrigerator models (e.g., side-by-side refrigerator and freezer compartments), stand-alone freezers, walk-in freezers, and/or other food storage appliances. The ice cream maker 200 may be positioned and/or mounted within the freezer compartment 104. The refrigerator 100 may include an access panel (e.g., door) for selectively accessing the freezer compartment 104. For example, the access panel may be a refrigerator door (e.g., where the freezer compartment 104 and the refrigeration compartment 102 are configured side-by-side). In some embodiments, the ice cream maker 200 may be slidably mounted (e.g., on tracks, rails, etc.) within the freezer compartment 104, where a user may move the ice cream maker 200 at least partially out of the freezer compartment 104 to access the ice cream maker 200. In some embodiments, the ice cream maker 200 may be included within a drawer assembly for use within a freezer compartment 104 of a different type of food storage appliance, similar to the freezer drawer 105, as described herein.

With reference to FIGS. 2A, 7A, and 8A, the freezer drawer 105 is slidably mounted (e.g., on rollers/tracks, rails, etc.) within the freezer compartment 104, where the freezer drawer 105 is configured to move between the first position (e.g., closed) and the second position (e.g., open) and/or positions therebetween (e.g., partially open). The freezer drawer 105 may be generally smaller than the freezer compartment 104. For example, there may be space between the freezer drawer 105 and a rear wall of the freezer compartment 104 when the freezer drawer 105 is in the closed position. In some embodiments, the freezer drawer 105 may include a front portion, where the front portion may include a handle. In some embodiments, the front panel of the freezer drawer 105 may be the access panel for selectively accessing the freezer compartment 104. The freezer drawer 105 may further include a plurality of walls, where the plurality of walls and the front portion define the freezer drawer 105. In some embodiments, the freezer drawer 105 is defined by a plurality of frame members connected to the front portion. The freezer drawer 105 may further include one or more freezer drawer bins mounted within the freezer drawer 105 and configured to store objects (e.g., food, ice, ice packs, gel packs, etc.). The one or more freezer drawer bins may be slidably mounted within the freezer drawer 105 (e.g., to access each bin, and store the bins efficiently within the freezer drawer 105).

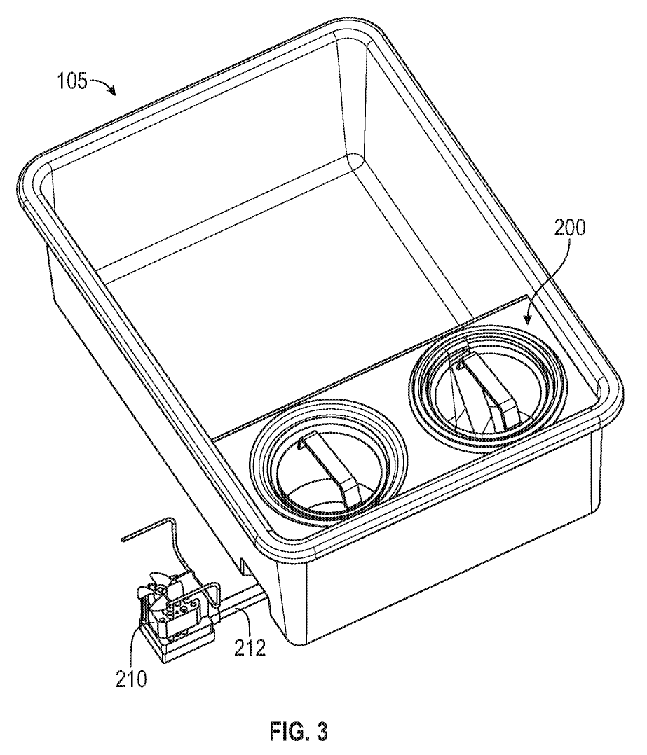

Referring to FIGS. 2B-5B, the ice cream maker 200 includes a housing 201 connected to the interior surface of the freezer drawer 105, where the housing 201 defines an opening 202. The ice cream maker 200 further includes a bowl 204 positioned within the opening 202 of the housing 201. The bowl 204 is rotatable relative to the housing 201. The ice cream maker 200 further includes a mixing blade 205 fixedly coupled to the housing 201 and extending into the bowl 204. The mixing blade 205 may extend into the opening 202 of the housing 201. The ice cream maker 200 further includes a rotatable plate 206 connected to a bottom surface 240 of the bowl 204. The ice cream maker 200 further includes a motor 210 and a drive shaft 212 movably connected to the rotatable plate 206, where the motor 210 rotates the bowl 204 relative to the mixing blade 205 using the rotatable plate 206.

The housing 201 of the ice cream maker 200 is mounted to the interior surface of the freezer drawer 105. The housing 201 may be mounted using fasteners (e.g., screws, bolts, rivets). For example, the housing 201 may be mounted to a side wall of the freezer drawer 105, where the ice cream maker 200 is positioned biased toward a side of the freezer drawer 105. In some embodiments, the interior surface of the freezer drawer 105 may be an interior surface of one of the freezer drawer bins. In some embodiments, the ice cream maker 200 is mounted to be removable from the freezer drawer 105. In some embodiments, where the refrigerator 100 is configured without the freezer drawer 105, the housing 201 may be mounted to an interior surface of the freezer compartment 104. In some embodiments, the housing 201 may be mounted to the freezer compartment 104 (e.g., to the interior surface thereof) using tracks and/or rails, where the ice cream maker 200 is slidably mounted within the freezer compartment 104.

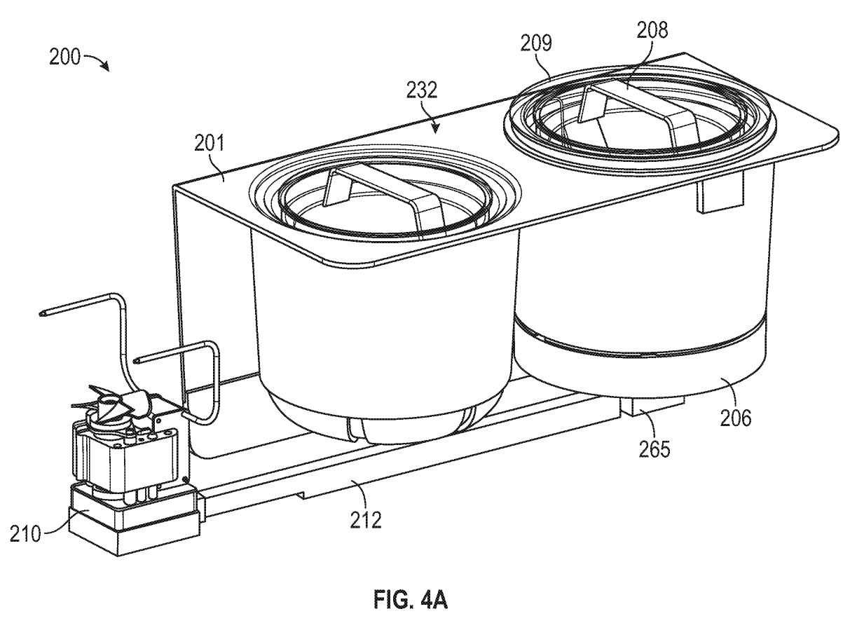

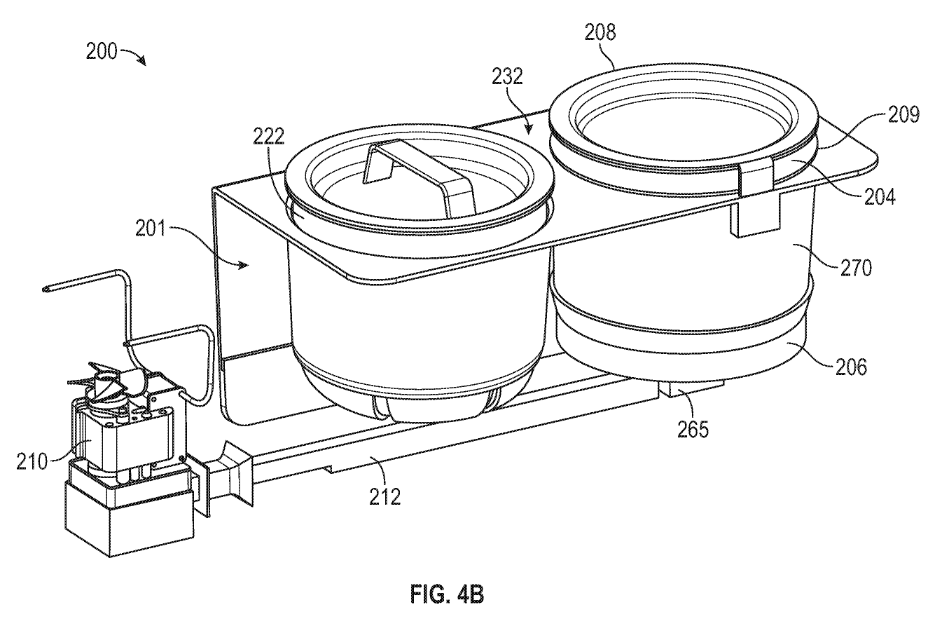

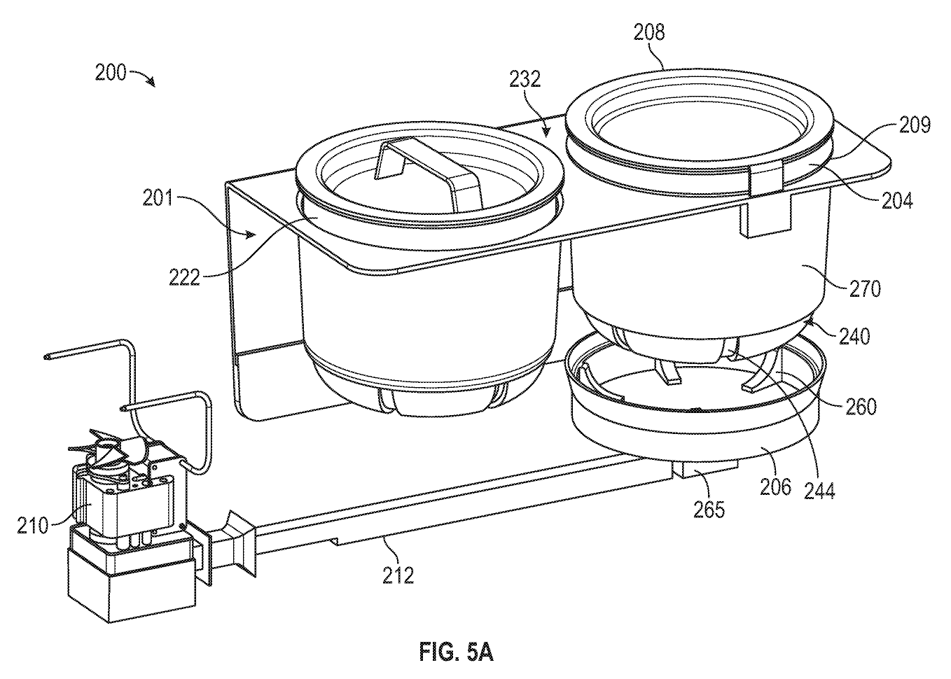

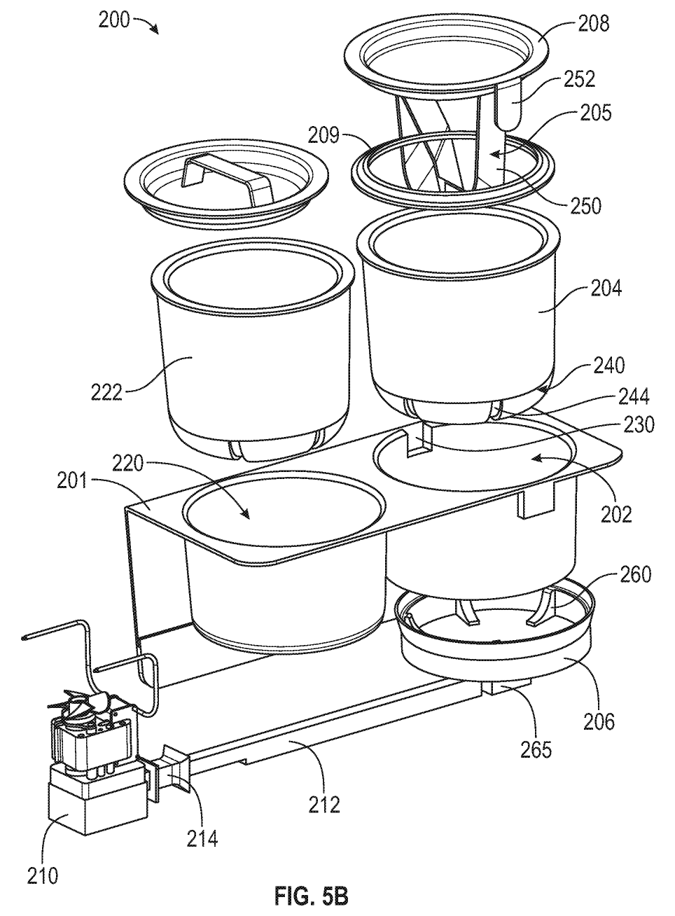

Referring to FIGS. 4A-5B, the opening 202 may be defined in the housing 201 extending through a top surface 232 of the housing 201. The bowl 204 may be positioned within the opening 202, where the bowl 204 is removable from the opening 202. The bowl 204 may be made from insulated aluminum to help maintain a cold temperature for ice cream to be stored (e.g., if taken outside the freezer compartment 104). In some embodiments, the housing 201 may further include a second opening 220 defined in the housing 201 adjacent to the opening 202 (e.g., a first opening). A second bowl 222 may be positioned within the second opening 220. The second bowl 222 may be configured similarly to the bowl 204, as described herein. The ice cream maker 200 may utilize additional bowls to store made ice-cream (e.g., to make and store multiple batches of ice cream in the freezer drawer 105). For example, the ice cream maker 200 may be configured to make ice cream using the bowl 204 positioned within the opening 202 using the rotatable plate 206, where the second bowl 222 contains made ice-cream and sits in the second opening 220 for storage of said ice cream. In some embodiments, the housing 201 may define additional openings. In some embodiments, the housing 201 may be made from sheet metal, where the sheet metal is bent to form the housing 201.

The bowl 204 includes a lip on an outer edge 242 of the bowl 204 and extending around a circumference of the bowl 204. The lip extends outward from the outer edge 242. With reference to FIG. 4A, the lip of the bowl 204 rests on the top surface 232 of the housing 201 when the bowl 204 is positioned within the opening 202. In other words, the lip of the bowl 204 is slightly larger than the rest (e.g., a body) of the bowl 204, so the lip may retain the bowl 204 in the opening 202, since the lip configures the bowl 204 with the outer edge 242 of the bowl 204 having a greater circumference than the opening 202.

In some embodiments, the bowl 204 may be otherwise retained in the opening 202 of the housing 201. With reference to FIGS. 4B and 5A, the housing 201 may include an extended portion 270, extending from (e.g., downward from) the top surface 232, where the extended portion 270 retains (e.g., via friction) the bowl 204 within the opening 202. The opening 202 may be defined from the top surface 232 through the extended portion 270. For example, the extended portion 270 may narrow as it extends away from the top surface 232, so the bowl 204 does not fall through the opening 202 and is instead retained by the housing 201, where the bowl 204 narrows near the bottom surface 240 of the bowl 204. The bottom surface 240 of the bowl 204 may extend past the extended portion 270, so the rotatable plate 206 may engage the bowl 204. In some embodiments, the bowl 204 may be configured with the lip and the housing 201 may be configured with the extended portion 270, where either mechanism may be used to retain the bowl 204 within the housing 201. In some embodiments, the housing 201 may include an extended portion defining the second opening 220, where the second bowl 222 is similarly retained to the bowl 204 in the housing 201.

Referring to FIGS. 4A-6B, the mixing blade 205 is mounted to the housing 201, where the mixing blade 205 is fixed while the bowl 204 is rotated relative to the mixing blade 205. The mixing blade 205 is configured for making ice cream (e.g., mixing ingredients using the mixing blade 205 to create ice cream). For example, the mixing blade 205 may be generally U-shaped and/or V-shaped, so the mixing blade 205 may connect to the housing 201 while extending into the bowl 204 and/or the opening 202 of the housing 201. In some embodiments, the mixing blade 205 includes a mixing portion 250, and a first end, and a second end. The first end and the second end may be positioned opposite each other. The mixing portion 250 is positioned within the bowl 204, while the ends of the mixing blade 205 extend outward from the mixing portion 250. The ends of the mixing blade 205 may extend outside of the bowl 204 (e.g., an interior volume thereof). The mixing blade 205 may further includes the ends bent downward (e.g., forming a U-shaped portion at the ends). In some embodiments, the ends of the mixing blade 205 may bend downwards to connect to the bowl 204 (e.g., hook onto an outer edge 242 of the bowl 204).

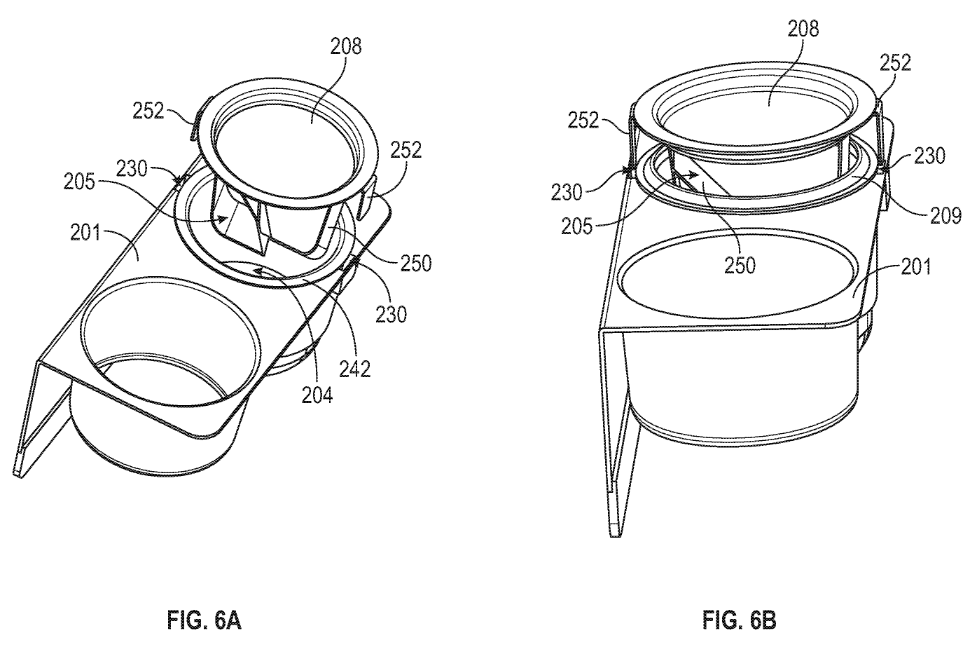

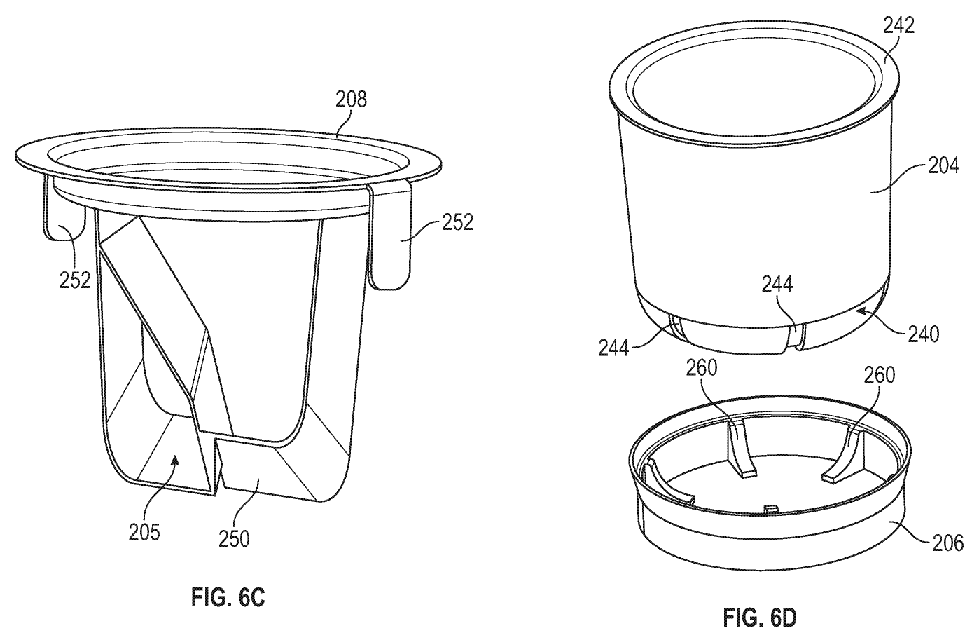

Referring to FIGS. 5A-6B, the housing 201 further includes one or more grooves 230 formed in the housing 201 around a circumference of the opening 202. The ends of the mixing blade 205 are inserted into the one or more grooves 230 to connect the mixing blade 205 to the housing 201. The one or more grooves 230 may be configured to correspond to the ends of the mixing blade 205 (e.g., positioned to align with the ends of the mixing blade 205 when inserted into the bowl 204 or opening 202 of the housing 201). The one or more grooves 230 fix the mixing blade 205 to the housing 201 so the bowl 204 may be rotated relative to the mixing blade 205. The one or more grooves 230 may include a number of grooves equal to a number or ends of the mixing blade 205. In some embodiments, there may be more or less grooves than ends of the mixing blade 205.

Referring to FIGS. 4A-6B, the ice cream maker 200 may further include a lid 208. The lid 208 is configured to be positioned over the bowl 204. For example, the lid 208 may be positioned on the bowl 204 where the lid 208 rests on the outer edge 242 of the bowl 204. The lid 208 is further configured to be positioned over the mixing blade 205 to help retain the mixing blade 205 (e.g., the mixing portion 250) within the bowl 204. In other words, the lid 208 prevents the mixing blade 205 and/or ice cream from spilling from the bowl 204 during operation of the ice cream maker 200. In some embodiments, the lid 208 includes a lower portion configured to be at least partially inserted into the bowl 204, and an upper portion configured to cover the bowl 204 (e.g., at least partially rest on the lip of the bowl 204). The upper portion may have a greater circumference than the lower portion. In some embodiments, the lid 208 includes a handle for placing and/or removing the lid 208 from the bowl 204.

Referring to FIGS. 5A-6C, the lid 208 of the ice cream maker 200 may include the mixing blade 205. The mixing blade 205 may be the mixing portion 250, where the mixing portion 250 extends from the lower portion of the lid 208. The lid 208 may further include one or more attachment portions 252 positioned around an outer circumference of the lid 208, where the attachment portions 252 extend from (e.g., extend downward from) the lid 208. The attachment portions 252 are configured to be inserted into the one or more grooves 230 of the housing 201. The attachment portions 252 may extend downward from the upper portion (e.g., an upper edge) of the lid 208. The one or more attachment portions 252 may include a number of attachment portions equal to a number of grooves of the one or more grooves 230 in the housing. In some embodiments, there may be more grooves and/or less grooves than attachment portions 252. In other words, when the lid 208 includes the mixing blade 205, the one or more attachment portions 252 of the lid 208 may be similar to the ends of the mixing blade 205 for connecting the lid 208 to the housing 201 using the one or more grooves 230 so the bowl 204 may be rotated relative to the mixing blade 205 for making ice cream.

Referring to FIGS. 5A-5B, the ice cream maker 200 may further include a retainer 209 (e.g., locking flange, retaining ring, etc.) . The retainer 209 may be positioned above the outer edge 242 of the bowl 204 and below the lid 208. The lid 208 may be positioned on the retainer 209 to cover the bowl 204. In other words, the retainer 209 may be a buffer between the lid 208 and the bowl 204 when the bowl 204 is rotating, so the lid 208 may still cover the bowl 204, while limiting interference between the lid 208 and the bowl 204 during rotation. In some embodiments, the retainer 209 may be positioned over the mixing blade 205, where the retainer 209 maintains the mixing blade 205 within the housing 201 (e.g., in the one or more grooves 230) while the bowl 204 is rotated (e.g., by preventing the mixing blade 205 from popping out of the grooves 230, while limiting interference between the ends of the mixing blade 205 and the bowl 204 during rotation).

Referring to FIGS. 4A-5B and 6D, the rotatable plate 206 is connected to the bottom surface 240 of the bowl 204, so the bowl 204 may be rotated by the rotatable plate 206 for making ice cream. The bowl 204 includes one or more grooves 244 formed in the bottom surface 240 of the bowl 204. The rotatable plate 206 includes one or more protrusions 260 configured to mate with the one or more grooves 244 of the bowl 204. The one or more protrusions 260 are formed on the rotatable plate 206 to align with the one or more grooves 244 on the bowl 204. For example, the one or more protrusions 260 may be formed around a circumference of the rotatable plate 206. A number of grooves formed in the bottom surface 240 of the bowl 204 may be equal to a number of protrusions formed on the rotatable plate 206. In some embodiments, there may be more grooves and/or less grooves formed in the bottom surface 240 of the bowl 204 than protrusions formed on the rotatable plate 206.

In some embodiments, the rotatable plate 206 may connect to the bowl 204 using a different mechanism. For example, the rotatable plate 206 may include a protrusion (e.g., a peg) formed in a center of the rotatable plate 206 configured to connect to a mounting opening (e.g., a hole) formed in the bottom surface 240 of the bowl 204. The protrusion and the opening may be geometrically shaped (e.g., star, hexagon) to provide for force through the mating of the protrusion and the opening for rotating the bowl 204 (e.g., through sides of the protrusion and the opening mating). In some embodiments, the protrusion and the opening may be threaded for mating of the rotatable plate 206 and the bowl 204 to provide for rotation of the bowl 204. In some embodiments, the protrusion may be off-center (e.g., biased) on the rotatable plate 206 for mating with a corresponding off-center opening in the bowl 204 for rotation (e.g., using a cylindrical peg and hole mating).

Referring to FIGS. 4A-4B, the ice cream maker 200 includes the motor 210 and the drive shaft 212 movably connected to the motor 210 and the rotatable plate 206, where the motor 210 may rotate the bowl 204 using the rotatable plate 206. The ice cream maker 200 may further include one or more gears 265 (e.g., a gearbox) positioned between the drive shaft 212 and the rotatable plate 206, where the one or more gears 265 are configured to change an axis of rotation of the rotatable plate 206 relative to the drive shaft 212. For example, the rotatable plate 206 may rotate on an axis of rotation perpendicular to an axis of rotation of the drive shaft 212.

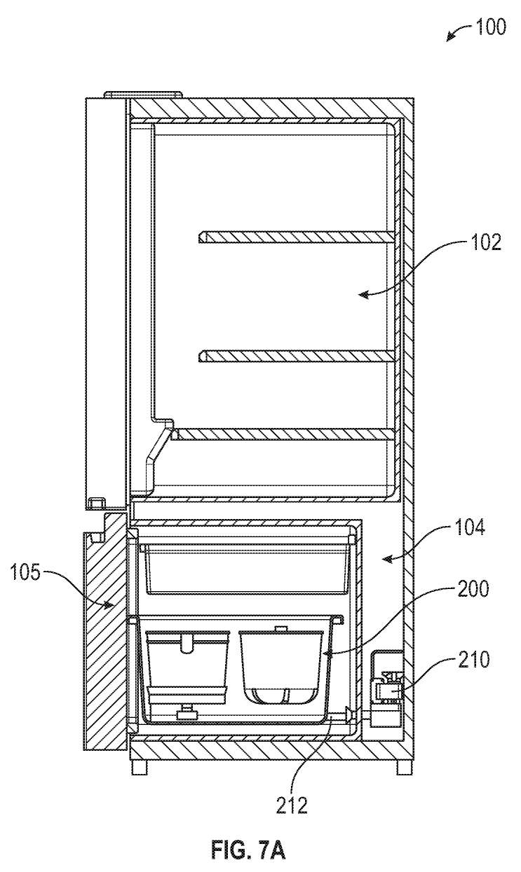

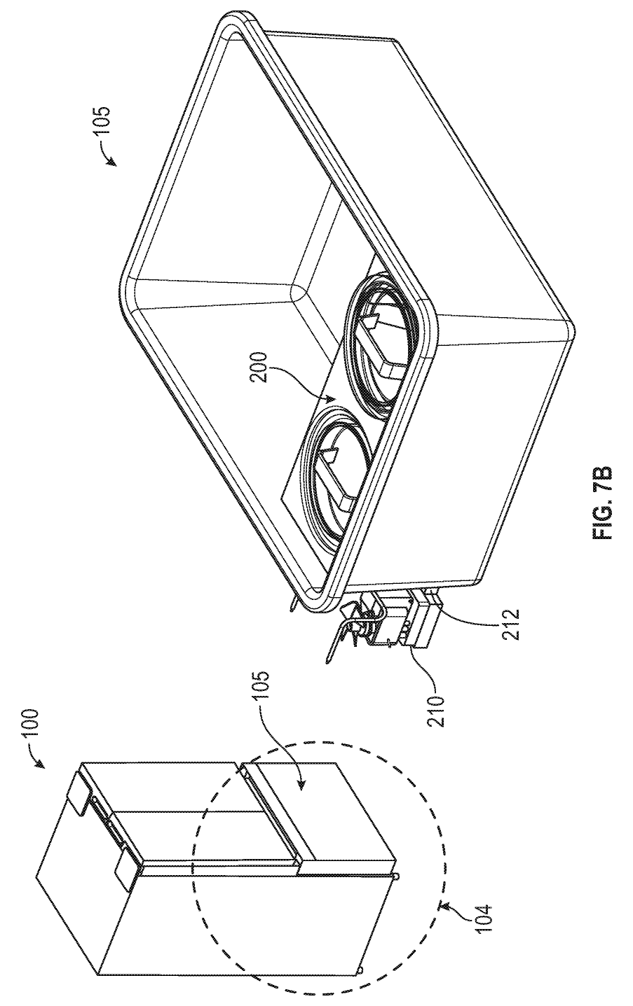

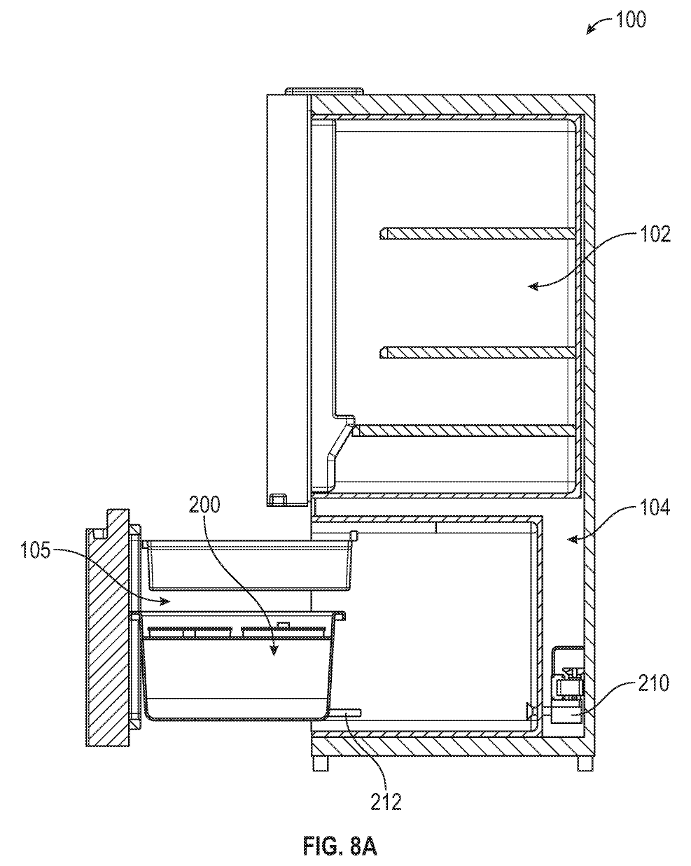

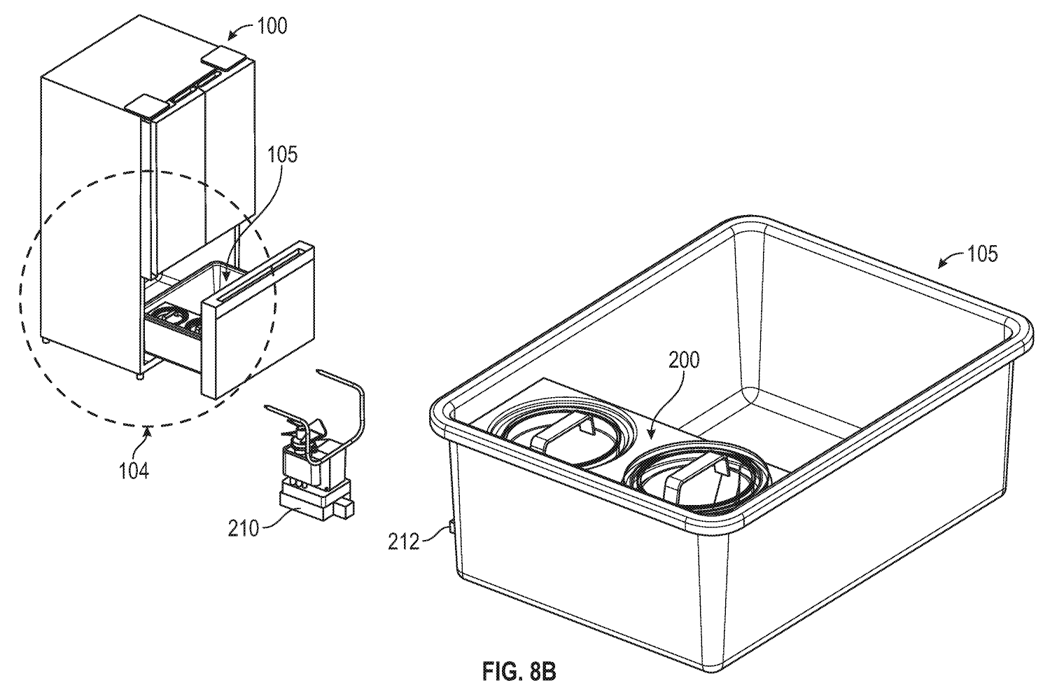

Referring to FIGS. 2B, 3, 7B, and 8B, the motor 210 is positioned rearward of the freezer drawer 105, where the drive shaft 212 extends from the motor 210 and into the freezer drawer 105. The motor 210 may be mounted in the freezer compartment 104 (e.g., on an internal surface of a wall of the refrigerator 100). For example, the motor 210 may be mounted on a rear wall of the freezer compartment 104 (see FIGS. 7A and 8A).

The drive shaft 212 extends to the rotatable plate 206, where a first end (e.g., a fixed end) of the drive shaft 212 is coupled to the rotatable plate 206 and/or the one or more gears 265 connected to the rotatable plate 206. The drive shaft 212 is movably connected to the motor 210, where the drive shaft 212 engages with the motor 210 when the freezer drawer 105 is in the first position (e.g., closed position) and disengages with the motor 210 when the freezer drawer 105 is in a second position (e.g., open position).

The motor 210 may include a drive shaft connector 214 configured to receive a second end (e.g., a free end) of the drive shaft 212, where the drive shaft connector 214 coupled the drive shaft 212 to the motor 210 when the freezer drawer 105 is in the first position. The drive shaft 212 may be retained within the motor 210 (e.g., within the drive shaft connector 214) via a seal of the freezer drawer 105 and the freezer compartment 104. In other words, the freezer drawer 105 being closed may prevent the drive shaft 212 from walking-out of the motor 210 during operation of the ice cream maker 200 due to the seal that forms when closing the freezer drawer 105 to maintain cold temperatures in the freezer compartment 104 and energy efficiency of the refrigerator 100. In some embodiments, the drive shaft connector 214 may include a locking mechanism that retains the drive shaft 212 when connected to the motor 210. The locking mechanism may be released be opening the freezer drawer 105.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (e.g., any combination of X, Y, and Z). Thus, such conjunctive language is not generally intended to imply that certain embodiments require at least one of X, at least one of Y, and at least one of Z to each be present, unless otherwise indicated.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

As will be understood by one skilled in the art, for any and all purposes, particularly in terms of providing a written description, all language such as “up to,” “at least,” “greater than,” “less than,” and the like, include the number recited and may refer to ranges which may be subsequently broken down into subranges. As will be understood by one skilled in the art, a range includes each individual member.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Other embodiments are set forth in the following claims.

What is claimed is:

1. A refrigerator comprising:
a refrigeration compartment and a freezer compartment;
a freezer drawer configured for selectively accessing the freezer compartment;
an ice cream maker mounted within the freezer compartment, the ice cream maker comprising:
a motor positioned rearward of the freezer drawer; and
a drive shaft movably connected to the motor and extending at least partially within the freezer drawer;
wherein the drive shaft engages with the motor when the freezer drawer is in a first position and disengages with the motor when the freezer drawer is in a second position.

2. The refrigerator of claim 1, wherein the ice cream maker further comprises a housing mounted to an interior surface of the freezer drawer.

3. The refrigerator of claim 2, wherein the ice cream maker further comprises a bowl positioned within an opening defined in the housing, the bowl rotatable relative to the housing.

4. The refrigerator of claim 3, wherein the ice cream maker further comprises a mixing blade fixedly coupled to the housing, wherein the mixing blade extends within the opening of the housing and into the bowl.

5. The refrigerator of claim 4, wherein the housing further comprises one or more grooves formed in the housing around a circumference of the opening, wherein ends of the mixing blade are configured to be inserted into the one or more of grooves.

6. The refrigerator of claim 4, wherein the ice cream maker further comprises a rotatable plate configured to connect to a bottom of the bowl.

7. The refrigerator of claim 6, wherein the rotatable plate comprises one or more protrusions and the bowl comprises one or more grooves formed in the bottom of the bowl, and wherein the one or more protrusions of the rotatable plate mate with the one or more grooves of the bowl.

8. The refrigerator of claim 6, wherein the drive shaft is coupled to the rotatable plate, and wherein the motor rotates the rotatable plate and the bowl relative to the mixing blade.

9. The refrigerator of claim 6, wherein the ice cream maker further comprises one or more gears positioned between the drive shaft and the rotatable plate, wherein the one or more gears change an axis of rotation of the rotatable plate relative to the drive shaft.

10. The refrigerator of claim 5, wherein the ice cream maker further comprises a retainer positioned over an outer edge of the bowl, wherein the retainer maintains a lid covering the bowl during rotation of the bowl.

11. The refrigerator of claim 3, wherein the bowl includes a lip on an outer edge of the bowl, the lip extending around a circumference of the bowl, and wherein the lip rests on a top surface of the housing when the bowl is inserted into the opening.

12. A food storage appliance comprising:
a freezer compartment; and
an ice cream maker positioned within the freezer compartment, the ice cream maker comprising:
a housing connected to an interior surface of the freezer compartment, the housing defining an opening;
a bowl positioned within the opening of the housing and rotatable relative to the housing;
a mixing blade fixedly coupled to the housing and extending within the opening of the housing into the bowl;
a rotatable plate connected to a bottom surface of the bowl; and
a motor and a drive shaft movably connected to the rotatable plate, wherein the motor rotates the bowl relative to the mixing blade using the rotatable plate.

13. The food storage appliance of claim 12, wherein the bowl comprising one or more grooves formed in a bottom of the bowl, and the rotatable plate comprising one or more protrusions configured to mate with the one or more grooves of the bowl.

14. The food storage appliance of claim 12, wherein the mixing blade comprises a first end, a mixing portion, and a second end, and wherein the mixing portion is positioned within the bowl, and the first end and the second end extend outward from the mixing portion and outside the bowl.

15. The food storage appliance of claim 14, wherein the mixing blade further comprises the first end and the second end bent downward.

16. The food storage appliance of claim 15, wherein the housing further comprises one or more grooves formed in the housing around a circumference of the opening, and wherein the first end and the second end of the mixing blade are inserted into the one or more grooves to connect the mixing blade to the housing.

17. The food storage appliance of claim 12, wherein the ice cream maker further comprises one or more gears positioned between the drive shaft and the rotatable plate, wherein the one or more gears change an axis of rotation of the rotatable plate relative to the drive shaft.

18. The food storage appliance of claim 12, wherein the ice cream maker further comprises a retainer positioned over an outer edge of the bowl, wherein the retainer maintains a lid on the bowl during rotation of the bowl.

19. The food storage appliance of claim 12, wherein the bowl comprises a lip positioned on an outer edge of the bowl and extending around a circumference of the bowl, and wherein the lip rests on a top surface of the housing when the bowl is inserted into the opening.

20. The food storage appliance of claim 12, wherein the housing further includes a second opening defined in the housing adjacent to the opening, and wherein a second bowl is positioned within the second opening.
